(19) United States
(12) Patent Application Publication
(10) Pub. No.: US 2022/0150583 A1
(43) Pub. Date: May 12, 2022

(54) ELECTRONIC APPARATUS AND CONTROL METHOD THEREOF

(71) Applicant: Samsung Electronics Co., Ltd., Suwon-si (KR)

(72) Inventors: Hyunwoo CHUN, Suwon-si (KR); Wonkyun Kim, Suwon-si (KR)

(73) Assignee: Samsung Electronics Co., Ltd., Suwon-si (KR)

(21) Appl. No.: 17/512,075

(22) Filed: Oct. 27, 2021

(30) Foreign Application Priority Data
Nov. 6, 2020 (KR) 10-2020-0147409

(51) Int. Cl. H04N 21/442; H04N 21/45; H04N 21/466; G06N 3/08; G06N 3/04

(52) U.S. Cl. CPC H04N 21/44222; H04N 21/4532; G06N 3/04; G06N 3/08; H04N 21/4662

(57) ABSTRACT

An electronic apparatus and a control method thereof are provided. The electronic apparatus includes a processor configured to: obtain user data including a viewing history of a plurality of contents; determine a viewing tendency of a plurality of users based on the viewing history; identify user features corresponding to the viewing tendency based on first reference data regarding relations between user features of the plurality of users and the viewing tendency, the first reference data being provided based on viewing histories of the plurality of users for the plurality of contents; identify a target user having a user feature corresponding to a designated content feature based on second reference data regarding relations between the user feature and content features of the plurality of contents, the second reference data being provided based on the viewing history of the plurality of users; and perform a content-related operation regarding the target user.

### CROSS-REFERENCE TO RELATED THE APPLICATION

This application is based on and claims priority under 35 U.S.C. § 119 to Korean Patent Application No. 10-2020-0147409 filed on Nov. 6, 2020 in the Korean Intellectual Property Office, the disclosure of which is incorporated by reference herein in its entirety.

### BACKGROUND

### 1. Field

The disclosure relates to an electronic apparatus and a control method thereof, more specifically, an electronic apparatus and a control method thereof for inferring a user preference based on analyzing data regarding a viewing history of contents.

### 2. Description of Related Art

An electronic apparatus which is provided with a display such as a television (TV) receives various contents provided from an external source and displays an image thereof on the display.

As digital broadcasting continues to develop, there is a growing interest in customized advertising services that are different from simple exposure advertising services provided by conventional broadcasting. An example of such customized advertising services is targeted advertising for users of the electronic apparatus.

In order to efficiently provide the targeted advertising, it is important to identify features of the users, such as age, gender, area of residence, etc.

In addition, in an environment where household members commonly use the electronic apparatus, such as TV, it is necessary to accurately specify features of the users who are actually viewing contents among the household members.

### SUMMARY

Provided are an electronic apparatus and a control method thereof to identify features of a user based on viewing data of contents and efficiently provide targeted services.

Also provided are an electronic apparatus and a control method thereof to specify a user who is actually viewing a content among a plurality of users and more precisely provide the targeted services.

Additional aspects, features and advantages of the disclosure will be set forth in part in the description which follows, and in part, will be apparent from the following description or may be learned by practice of the disclosure.

In accordance with an aspect of the disclosure, there is provided an electronic apparatus including: a processor configured to: obtain user data regarding a viewing history of a plurality of contents for each of a plurality of users; determine a viewing tendency of each of the plurality of users based on the viewing history; identify at least two user features corresponding to the viewing tendency based on first reference data regarding relations between user features of the plurality of users and the viewing tendency, the first reference data being provided based on viewing histories of the plurality of users for the plurality of contents; identify a target user having a user feature corresponding to a designated content feature among at least two users having the identified at least two user features based on second reference data regarding relations between the user feature and content features of the plurality of contents, the second reference data being provided based on the viewing history of the plurality of users; and perform a content-related operation regarding the target user.

The user feature corresponds to one of a plurality of groups which are divided according to at least one of age or gender of the plurality of users.

The designated content feature is determined based on at least one of genre or time section of a content among the plurality of contents.

The electronic apparatus further includes an interface circuitry, and the processor is further configured to receive viewing data regarding the plurality of contents from an external apparatus through the interface circuitry, and obtain the user data regarding the viewing tendency from the viewing data.

The processor is further configured to classify and map viewing data of the plurality of contents collected from a plurality of external apparatuses, to the content features of the plurality of contents, and obtain, from the classified and mapped viewing data, feature data which indicates whether to view at each of the plurality of external apparatuses for the content features.

The processor is further configured to identify the at least two user features corresponding to the viewing tendency of the user data by performing learning based on the first reference data, and the first reference data comprises the classified and mapped viewing data to the content features and the obtained feature data.

The processor is further configured to identify the at least two user features which correspond to the viewing tendency by comparing the feature data obtained from an external apparatus and a user feature obtained from a learned model.

The learned model includes multi-layers.

The processor is further configured to obtain, from the classified and mapped viewing data, the feature data which indicates a viewing pattern of content for the at least two users having the at least two user features.

The processor is further configured to identify the target user having the user feature corresponding to the designated content feature by performing learning based on the second reference data, and the second reference data comprises the classified and mapped viewing data to the content features and the obtained feature data.

In accordance with an aspect of the disclosure, there is provided a method of controlling an electronic apparatus. The method includes: obtaining user data regarding a viewing history of a plurality of contents for each of a plurality of users; determine a viewing tendency of each of the plurality of users based on the viewing history; identifying at least two user features corresponding to the viewing tendency based on first reference data regarding relations between user features of the plurality of users and the viewing tendency, the first reference data being provided based on viewing histories of the plurality of users for the plurality of contents; identifying a target user having a user feature corresponding to a designated content feature among at least two users having the identified at least two user features based on second reference data regarding relations between the user feature and content features of the plurality of contents, the second reference data being provided based on the viewing history of the plurality of users, and performing a content-related operation regarding the target user.

The user feature corresponds to one of a plurality of groups which are divided according to at least one of age or gender of the plurality of users.

The designated content feature is determined based on at least one of genre or time section of a content among the plurality of contents.

The obtaining includes: receiving viewing data regarding the plurality of contents from an external apparatus through an interface circuitry, and obtaining the user data regarding the viewing tendency from the viewing data.

The method further includes: classifying and map viewing data of the plurality of contents collected from a plurality of external apparatuses, to the content features of the plurality of contents, and obtaining, from the classified and mapped viewing data, feature data which indicates whether to view at each of the plurality of external apparatuses for the content features.

The identifying the at least two user features includes identifying the at least two user features corresponding to the viewing tendency of the user data by performing learning based on the first reference data, and the first reference data comprises the classified and mapped viewing data to the content features and the obtained feature data.

The identifying the at least two user features comprises identifying the at least two user features which correspond to the viewing tendency of the user data by comparing the feature data obtained from an external apparatus and a user feature obtained from a learned model.

The classifying and mapping includes obtaining, from the classified and mapped viewing data, the feature data which indicates a viewing pattern of content for the at least two users having the at least two user features.

The identifying the target user includes identifying the target user having the user feature corresponding to the designated content feature by performing learning based on the second reference data, and the second reference data comprises the classified and mapped viewing data to the content features and the obtained feature data.

In accordance with an aspect of the disclosure, there is provided a non-transitory computer-readable recording medium storing instructions which are executed by an electronic apparatus to perform a method. The method includes: obtaining user data regarding a viewing history of a plurality of contents for each of a plurality of users; determining a viewing tendency of each of the plurality of users based on the viewing history; identifying at least two user features corresponding to the viewing tendency based on first reference data regarding relations between user features of the plurality of users and the viewing tendency, the first reference data being provided based on a viewing histories of the plurality of users for the plurality of contents; identifying a target user having a user feature corresponding to a designated content feature among the at least two users having the identified at least two user features based on second reference data regarding relations between the user feature and content features of the plurality of contents, the second reference data being provided based on the viewing history of the plurality of users, and performing a content-related operation regarding the target user.

### BRIEF DESCRIPTION OF THE DRAWINGS

The above and other aspects, features, and advantages of certain embodiments of the present disclosure will be more apparent from the following description, taken in conjunction with the accompanying drawings, in which:

FIG. 1 illustrates a system which includes an electronic apparatus according to an embodiment;

FIG. 2 illustrates a block diagram of an electronic apparatus according to an embodiment;

FIG. 3 illustrates a flowchart of control operations of an electronic apparatus according to an embodiment;

FIG. 4 illustrates a block diagram of a processor of an electronic apparatus according to an embodiment;

FIG. 5 illustrates a flowchart indicating control operations of identifying a user of an electronic apparatus and one or more features of the user according to an embodiment;

FIG. 6 illustrates operations of a data preprocessor of an electronic apparatus according to an embodiment;

FIG. 7 illustrates operations of a first feature obtaining part of an electronic apparatus according to an embodiment;

FIG. 8 illustrates operations of a first learning modelling part of an electronic apparatus according to an embodiment;

FIG. 9 illustrates operations of a demographic inferring part of an electronic apparatus according to an embodiment;

FIG. 10 illustrates operations of a second feature obtaining part of an electronic apparatus according to an embodiment;

FIG. 11 illustrates operations of a second learning modelling part of an electronic apparatus according to an embodiment; and

FIG. 12 illustrates operations of a user inferring part of an electronic apparatus according to an embodiment.

### DETAILED DESCRIPTION

Hereinafter, embodiments of the disclosure will be described in detail with reference to the accompanying drawings. In the drawings, the same reference numbers or signs refer to components that perform substantially the same function, and the size of each component in the drawings may be exaggerated for clarity and convenience. However, the technical idea and the core configuration and operation of the disclosure are not only limited to the configuration or operation described in the following examples. In describing the disclosure, if it is determined that a detailed description of the known technology or configuration related to the disclosure may unnecessarily obscure the subject matter of the disclosure, the detailed description thereof will be omitted.

In embodiments of the disclosure, terms including ordinal numbers such as first, second and etc. are used only for the purpose of distinguishing one component from other components, and singular expressions include plural expressions unless the context clearly indicates otherwise. Also, in embodiments of the disclosure, it should be understood that terms such as ‘comprise’, ‘configured’, ‘include’, and ‘have’ do not preclude the existence or addition possibility of one or more other features or numbers, steps, operations, components, parts, or combinations thereof. In addition, in the embodiment of the disclosure, a ‘module’ or a ‘unit’ performs at least one function or operation, and may be embodied in hardware or software, or a combination of hardware and software, and may be integrated into at least one module. In addition, in embodiments of the disclosure, at least one of the plurality of elements refers to not only all of the plurality of elements, but also each one or all combinations thereof excluding the rest of the plurality of elements.

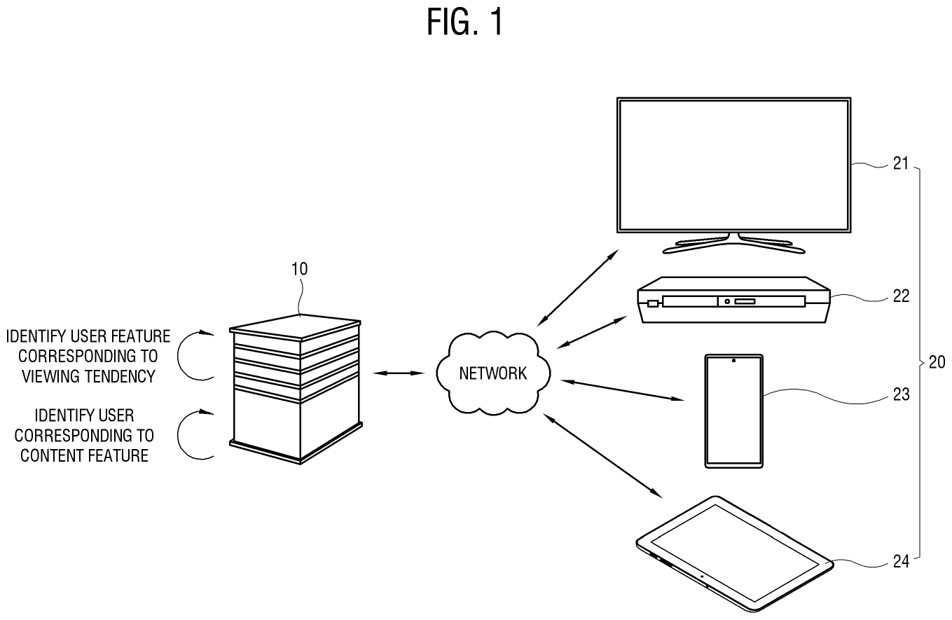

FIG. 1 illustrates a system which includes an electronic apparatus according to an embodiment.

According to an embodiment, an electronic apparatus 10 may be embodied as, for example, a server, and communicate with at least one of external apparatuses 20 through a network. However, the embodiment of the electronic apparatus 10 is not limited to the server, but may be embodied with various types of apparatuses.

As an example, a plurality of the electronic apparatuses 10 may be provided. The plurality of electronic apparatuses 10 may operate in conjunction with each other, and share related operations.

The external apparatuses 20 may be embodied as a media apparatus for playing a content and includes, for example, a display apparatus 21 such as TV, an image processing apparatus 22 such as set-top box which transmits a signal to an external display wired or wirelessly connected, terminal apparatuses, that is, mobile apparatuses 23 such as smart phone, tablet 24, smart pad, etc. However, the embodiment of the external apparatuses 20 is not limited to the above examples, but may be applied, as other examples, to a personal computer (PC) such as desktop, laptop, etc. or a monitor for the PC.

In an embodiment, the external apparatus 20 may be embodied as a display apparatus 21 including a display to display an image. The external apparatus 20 receives a signal, for example, data of content provided from an external signal source and processes the received data of the content in accordance with a preset process to display an image on the display.

According to an embodiment, the external apparatus 20 embodied as the display apparatus 21 may be embodied as, for example, a TV capable of processing a broadcast image based on at least one of a broadcast signal, broadcast information or broadcast data received from a transmitter of a broadcasting station. The external apparatus 20 may include a tuner to perform tuning to a broadcast signal for each channel.

When the external apparatus 20 is a TV, the external apparatus 20 may receive broadcast content based on at least one among a broadcast signal, broadcast information or broadcast data from a transmitter of a broadcasting station directly or through an additional apparatus connectable with the external apparatus 20 by a cable, for example, through a set-top box (STB), a one-connect box (OC box), a media box, etc. Here, the connection between the external apparatus 20 and the additional apparatus is not limited to the cable, but may be implemented with various wired/wireless interfaces.

The external apparatus 20 may, for example, wirelessly receive broadcast content as a radio frequency (RF) signal transmitted from the broadcasting station. To this end, the external apparatus 20 may include an antenna for receiving a signal.

In the external apparatus 20, the broadcast content may be received through a terrestrial wave, a cable, a satellite, etc., and a signal source is not limited to the broadcasting station. In other words, any apparatus or station capable of transmitting and receiving data may be included in the image source.

Standards of a signal received in the external apparatus 20 may be varied depending on the types of the apparatus, and the external apparatus 20 may receive a signal as an image content based on high definition multimedia interface (HDMI), HDMI-consumer electronics control (CEC), display port (DP), digital visual interface (DVI), composite video, component video, super video, DVI, Thunderbolt, RGB cable, syndicat des constructeurs d'appareils radiorécepteurs et téléviseurs (SCART), universal serial bus (USB), or the like standards through a line, in response to the wired interface circuitry which is provided to communicate externally.

According to an embodiment, the external apparatus 20 may be embodied, for example, by a smart TV or an Internet protocol (IP) TV. The smart TV may receive and display a broadcast signal in real time, support a web browsing function so that various pieces of content can be searched and consumed through the Internet while a broadcast signal is displayed in real time, and provide a convenient user environment for the web browsing function. Further, the smart TV may include an open software platform to provide an interactive service to a user. Therefore, the smart TV is capable of providing various contents, for example, content of an application for a predetermined service to a user through the open software platform. Such an application may refer to an application program for providing various kinds of services, for example, a social network service (SNS), finance, news, weather, a map, music, a movie, a game, an electronic book, etc.

The external apparatus 20 may provide, for example, a targeted service which corresponds to a user feature. The type of the targeted service is not limited but includes, for example, targeted advertising.

According to an embodiment, when household members commonly use the electronic apparatus 20, such as TV, a targeted service which corresponds to the feature of the user who is predicted to be actually viewing contents among the plurality of users may be determined. Such user and user feature may be identified by the electronic apparatus 10, and specific operations of identifying the user and the user feature will be described in detail in the following embodiments.

The external apparatus 20 may process a signal to display a moving image, a still image, an application, an on-screen display (OSD), a user interface (UI) for controlling various operations, etc. on a screen based on a signal/data stored in an internal/external storage medium.

The external apparatus 20 may use wired or wireless network communication to receive content from various sources including a server or a terminal apparatus providing a content, but there are no limits to the types of communication. The external apparatus 20 may receive content from a plurality of sources.

Specifically, the external apparatus 20 may use the wireless network communication to receive as image content a signal corresponding to standards of Wi-Fi, Wi-Fi Direct, Bluetooth, Bluetooth low energy, Zigbee, ultra-wideband (UWB), near field communication (NFC), etc. in response to the embodied form of the wireless interface circuitry provided to communicate externally. Further, the external apparatus 20 may receive a content signal through a wired network communication such as Ethernet.

According to an embodiment, the external apparatus 20 may receive content from a content provider, that is, a content server through the wired or wireless network. For example, the external apparatus 20 may be provided with a media file such as video on demand (VOD), a web content, etc. in streaming.

The external apparatus 20 may be provided with video content or media content such as VOD from a web server or an over-the-top (OTT) server able to provide OTT services.

The external apparatus 20 may output, that is, display an image corresponding to content through a display by executing an application for playing the content, for example, a VOD application to process the content which is received from a server, etc. Here, the external apparatus 20 may receive the content from the server or other sources by using a user account corresponding to the executed application.

The user may view various contents using the external apparatus 20. The external apparatus 20 may provide information on a viewing history of the contents (hereafter, also referred to as “content viewing history” or “viewing history information”) to the electronic apparatus 10.

The type of the viewing history information provided by the external apparatus 20 is not limited, but may include, for example, data of a viewing tendency regarding a plurality of contents which are viewed by a user through the external apparatus 20 (hereafter, also referred to as “user data”).

In the external apparatus 20, the viewing history of the user regarding the contents may be cumulatively stored. From the viewing history, data of the user's viewing tendency of the external apparatus 20 for the plurality of contents may be obtained. That is, the user's viewing tendency of the one or more external apparatuses 20 may be determined by analyzing the viewing history of contents by the user.

The electronic apparatus 10 may receive user data of the viewing tendency of the plurality of contents from the external apparatus 20 or receive the viewing history from the external apparatus 20 and determine user's viewing tendency.

In an embodiment, the electronic apparatus 10 may store and manage the data of the viewing tendency at each of the plurality of external apparatuses 20 according to identification information (ID) of each external apparatus 20.

The electronic apparatus 10 may identify a user feature for the external apparatus 20 based on the viewing history information which is obtained from the external apparatus 20 or the user data of the viewing tendency for the plurality of contents.

In an embodiment, when the electronic apparatus 20 is a commonly used device, such as a TV, by a plurality of users, the electronic apparatus 10 may identify two or more user features for the external apparatus 20. The electronic apparatus 10 may identify a user who has a user feature that corresponds to a certain content feature among two or more users who have the identified two or more user features.

Herein below, with reference to the accompanying drawings, configurations of the electronic apparatus according to an embodiment of the disclosure will be described.

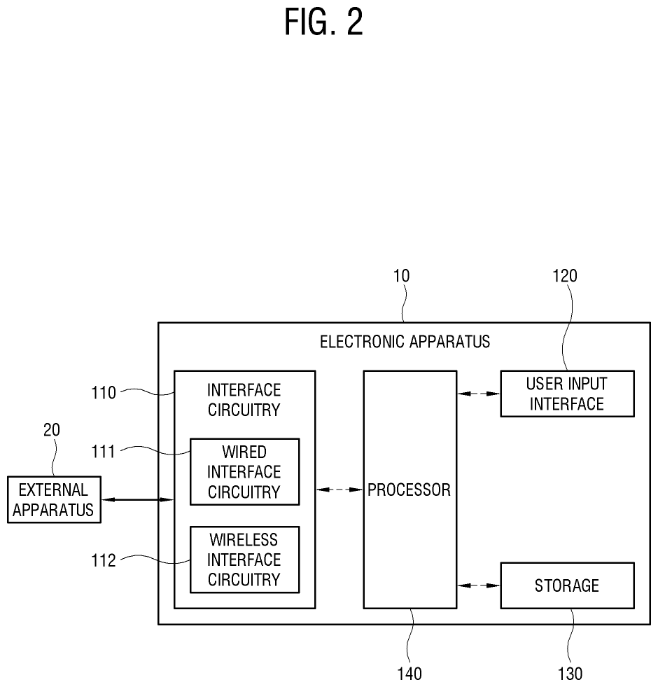

FIG. 2 illustrates a block diagram of an electronic apparatus according to an embodiment of the disclosure.

However, the configuration of the electronic apparatus according to an embodiment of the disclosure illustrated in FIG. 2 is merely an example, and the electronic apparatus of another embodiment may be implemented with other configurations different from the illustrated configuration. That is, the electronic apparatus 10 may include another configuration besides the configurations illustrated in FIG. 2, or may exclude at least one component or part from the embodiment illustrated in FIG. 2. Further, the electronic apparatus 10 may be embodied by changing some components or parts of those illustrated in FIG. 2.

The electronic apparatus 10 according to an embodiment of the disclosure, as illustrated in FIG. 2, includes an interface circuitry 110.

The interface circuitry 110 may include circuitry configured to allow the electronic apparatus 10 to communicate with at least one of various external apparatuses 20.

The interface circuitry 110 may include wired interface circuitry 111. The wired interface circuitry 111 may include a connector for transmitting/receiving a signal/data based on the standards such as, for example, and without limitation, HDMI, HDMI-CEC, USB, Component, DP, DVI, Thunderbolt, RGB cables, etc. Here, the wired interface circuitry 111 may include at least one connector, terminal or port respectively corresponding to such standards.

The wired interface circuitry 111 may include a connector, a port, etc. based on universal data transfer standards such as a USB port, etc. The wired interface circuitry 111 may include a connector, a port, etc. to which an optical cable based on optical transfer standards is connectable. The wired interface circuitry 111 may include a connector, a port, etc. which connects with an external microphone or an external audio apparatus having a microphone, and receives an audio signal from the audio apparatus. The interface circuitry 111 may include a connector, a port, etc. which connects with a headset, an earphone, an external loudspeaker or the like audio apparatus, and transmits or outputs an audio signal to the audio apparatus. The wired interface circuitry 111 may include a connector or a port based on Ethernet and the like network transfer standards. For example, the wired interface circuitry 111 may be embodied by a local area network (LAN) card or the like connected to a router or a gateway by a cable.

The wired interface circuitry 111 may be embodied by a communication circuitry including wireless communication modules (e.g. an S/W module, a chip, etc.) corresponding to various kinds of communication protocols.

The interface circuitry 110 may include wireless interface circuitry 112.

The wireless interface circuitry 112 may be variously embodied corresponding to the embodiments of the electronic apparatus 10. For example, the wireless interface circuitry 112 may use wireless communication based on RF, Zigbee, Bluetooth (BT), Bluetooth Low Energy (BLE), Wi-Fi, Wi-Fi direct, UWB, NFC or the like.

The wireless interface circuitry 112 may be embodied by communication circuitry including wired or wireless communication modules (e.g. an S/W module, a chip, etc.) corresponding to various kinds of communication protocols.

According to an embodiment, the wireless interface circuitry 112 may include a wireless local area network (WLAN) unit. The WLAN unit may be wirelessly connected to external apparatuses through an access point (AP) under control of the processor 140. The WLAN unit includes a Wi-Fi communication module.

According to an embodiment, the wireless interface circuitry 112 may include a wireless communication module supporting one-to-one direct communication between the electronic apparatus 10 and the external apparatus 20 wirelessly without the AP. The wireless communication module may be embodied to support Wi-Fi direct, BT, BLE, or the like communication method. When the first electronic apparatus 101 performs direct communication with the external apparatus, the storage 130 may be configured to store identification information (e.g. media access control (MAC) address or Internet protocol (IP) address) about the external apparatus with which the communication will be performed.

In the electronic apparatus 10 according to an embodiment, the wireless interface circuitry 112 may be configured to perform wireless communication with the external apparatus by at least one of the WLAN unit and the wireless communication module according to its performance.

According to an embodiment, the wireless interface circuitry 112 may further include a communication module based on various communication methods such as, for example, and without limitation, long-term evolution (LTE) or the like mobile communication, electromagnetic (EM) communication including a magnetic field, visible light communication (VLC), etc.

The wireless interface circuitry 112 may transmit or receive data packets with the external apparatus 20 by wirelessly communicating with the external apparatus 20 in a network.

The electronic apparatus 10 may include a user input interface 120.

The user input interface 120 may include various user input circuitry and transmit various preset control instructions or information to the processor 140 in response to a user input.

The user input interface 120 may be capable of receiving various types of user input.

The user input interface 120 may include, for example, and without limitation, a keypad (or an input panel) including a power key, a numeral key, a menu key or the like buttons provided in the main body of the electronic apparatus 10. The user input interface 120 may also include a touch screen.

According to an embodiment, the user input interface 120 may include an input device including circuitry that generates a command/data/information/signal previously set to remotely control the electronic apparatus 10 and transmits it to the electronic apparatus 10. The input device may include, for example, and without limitation, a remote controller, a keyboard, a mouse, etc. and receive a user input as separated from the main body of the electronic apparatus 10. The input device may be used as an external apparatus that performs wireless communication with the electronic apparatus 10, in which the wireless communication is based on Bluetooth, IrDA, RF communication, WLAN, or Wi-Fi direct.

The electronic apparatus 10 may include a storage 130.

The storage 130 may be configured to store various pieces of data of the electronic apparatus 10.

The storage 130 may be embodied by a nonvolatile memory (or a writable read only memory (ROM)) which can retain data even though the electronic apparatus 10 is powered off, and mirror changes. For example, the storage 130 may include one among a flash memory, an HDD, an erasable programmable ROM (EPROM) or an electrically erasable programmable ROM (EEPROM). The storage 130 may further include a volatile memory such as a dynamic random access memory (DRAM) or a static random access memory (SRAM), of which reading or writing speed for the electronic apparatus 10 is faster than that of the nonvolatile memory.

Data stored in the storage 130 may for example include not only an operating system (OS) for driving the electronic apparatus 10, but also various programs, applications, image data, appended data, etc. executable on the OS.

For example, the storage 130 may be configured to store a signal or data input/output corresponding to operations of the elements under control of the processor 140. The storage 130 may be configured to store a control program for controlling the electronic apparatus 10, an application provided by the manufacturer or downloaded from external devices or software, a relevant user interface (UI), images for providing the UI, user information, documents, databases, or the concerned data.

According to an embodiment, the storage 130 may store reference data for identifying the user feature and the user for the external apparatus 20.

The storage 130 may store first reference data for identifying the user feature of the external apparatus 20. Here, the first reference data may be provided based on the viewing history of the plurality of users of the plurality of contents and include relations between the viewing tendencies of the plurality of users and user features.

Also, the storage 130 may store second reference data for identifying a user who has the user feature that corresponds to a content feature among two or more users having two or more user features. Here, the second reference data is provided based on viewing history of a plurality of users and include relations between the user features and the content features of the plurality of contents.

In an embodiment, the first reference data and the second reference data may be obtained based on, as common raw data, viewing data of a plurality of users (e.g., general users) who are sampled.

The first reference data and the second reference data may be obtained the viewing data which is collected by, for example, the electronic apparatus 10 from the plurality of external apparatuses 20.

In another embodiment, the first reference data and the second reference data may be obtained based on sample data which is collected through, as a sample apparatus, a predefined plurality of media apparatuses, for example, TVs in which a viewing rate surveying means is installed. The sample data may include user feature information of each media apparatus, viewing history information, etc.

In an embodiment, the storage 130 may be provided with at least one database (DB). For example, the storage 130 may include a database in which the user feature information identified for the external apparatus 20 is stored and a database in which the user information identified to have the user feature that corresponds to a certain content feature is stored.

In an embodiment, the storage 130 may be provided with a database to store and manage the user feature information for each of the plurality of external apparatuses 20 and the user information corresponding to the content feature.

The term storage may include a read-only memory (ROM), a random access memory (RAM) or a memory card (for example, a micro SD card and a memory stick) that is mountable in the electronic apparatus 10.

The electronic apparatus 10 includes a processor 140.

The processor 140 may perform a control operation of the electronic apparatus 10. The processor 140 may include control programs (or instructions) for performing the control operation, a nonvolatile memory in which control programs are installed, a volatile memory in which at least a part of the installed control programs is loaded, and at least one general-purpose processor, such as a microprocessor, an application processor, or a central processing unit (CPU), for executing the loaded control programs.

The processor 140 may include a single core, a dual core, a triple core, a quad core, or a multiple-number core thereof. The processor 140 may include a plurality of processors, for example, a main processor and a sub processor operating in a sleep mode (for example, only standby power is supplied and does not operate as a display apparatus). In addition, the processor 140, the ROM, and the RAM can be interconnected via an internal bus.

According to an embodiment, the processor 140 may be implemented as a form included in a main system-on-chip (SoC) mounted on a PCB embedded in the electronic apparatus 10.

The control program may include one or more programs implemented in at least one of a basic input/output system (BIOS), a device driver, an operating system, firmware, a platform, and an application. According to an embodiment, the application may be pre-installed or stored in the electronic apparatus 10 at the time of manufacturing of the electronic apparatus 10, or installed in the electronic apparatus 10 based on data of the application received from the outside when used later. The data of the application may be downloaded to the electronic apparatus 10 from an external server such as an application market. Such an external server may be a computer program product, but is not limited thereto.

The control program may be recorded on a storage medium that may be read by a device such as a computer. The machine-readable storage medium may be provided in a form of a non-transitory storage medium. Here, the ‘non-transitory storage medium’ means that the storage medium is a tangible device, and does not include a signal (for example, electromagnetic waves), and the term does not distinguish between the case where data is stored semi-permanently on a storage medium and the case where data is temporarily stored thereon. For example, the ‘non-transitory storage medium’ may include a buffer in which data is temporarily stored.

The processor 140 identifies the user feature for the external apparatus 20 based on the viewing history information which is obtained from the external apparatus 20. Also, the processor 140 identifies a user who has the user feature corresponding to a certain content feature among the two or more users having the identified two or more user features.

Herein below, the external apparatus 20 will be described as a media apparatus, for example, a TV which is commonly usable by a plurality of uses, but the disclosure is not limited thereto. The external apparatus 20 may be a TV of a single-user household. Also, the external apparatus 20 may be a personal media apparatus such as a smartphone or tablet.

Also, an example of identifying the user feature and the user for a single external apparatus 20 will be described below, but the electronic apparatus 10 according to an embodiment of the disclosure may obtain the viewing history information from a plurality of external apparatuses 20 to identify the user feature and the user for each of the plurality of external apparatuses 20.

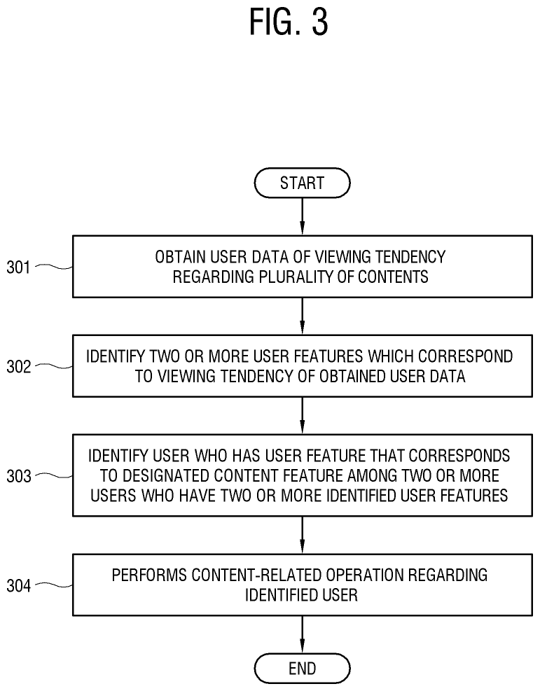

FIG. 3 illustrates a flowchart of control operations of the electronic apparatus according to an embodiment.

The processor 140 of the electronic apparatus 10, as illustrated in FIG. 3, may obtain the user data of the viewing history regarding the plurality of contents (operation 301). Here, a viewing tendency may be obtained from the viewing history data of the user for the plurality of contents which have been watched by the user through the external apparatus 20. For example, the viewing history data may include information regarding a genre, a viewing time, a duration, etc., and the viewing tendency may be determined based on the viewing history related to genre, viewing time, duration, and etc.

In an embodiment, the processor 140 receives the viewing history data of the plurality of contents from the external apparatus 20 through the interface circuitry 110 and obtains the user data of the viewing tendency from the received viewing history data.

In another embodiment, the processor 140 may receive the user data of the viewing tendency from the external apparatus 20 through the interface circuitry 110.

The processor 140 identifies two or more user features which correspond to the viewing tendency of the user data obtained in the operation 301 (operation 302).

Specifically, the processor 140 may identify the two or more user features corresponding to the viewing tendency of the user data obtained in the operation 301 based on first reference data regarding relations between the viewing tendencies of the plurality of users and the user features which are provided based on the viewing history of the plurality of users for the plurality of contents.

Here, the user features include human-related statistical information of the users, that is, demographic information such as age, gender, residence, income, etc. In an embodiment, the user features, that is, the demographic information may correspond to one among a plurality of groups which are divided by at least one of age or gender.

The processor 140 may identify a plurality of user features including ages, genders or combinations thereof. For example, the processor 140 may identify user features of three users, such as men in their thirties, women in their thirties, and babies/preschool children for the external apparatus 20 installed in a household as a TV.

The processor 140 identifies a user who has a user feature that corresponds to a designated content feature among two or more users who have been identified with one or more user features (operation 303).

Specifically, the processor 140 may identify the user who has the user feature that corresponds to the designated content feature among the two or more users who have the two or more user features identified in the operation 302 based on second reference data including relations between the content features of the plurality of contents and the user features which are provided based on the viewing history of the plurality of users for the plurality of contents.

Here, the content feature may be determined based on at least one of genre or broadcasting time of the content.

Specifically, the content feature may be defined by genre, broadcasting time such as weekdays or weekends, prime time, midnight, etc., broadcasting region such as metropolitan area, city or island area, etc., or a selective combination thereof of the content. For example, a genre of sports broadcasted at midnight, comedy at weekends' prime time, etc. may be defined as the content feature.

For example, in case of identifying men in their thirties, women in their thirties, and babies/preschool children as the two or more user features in the operation 302, among the two or more users (referred to as user1, user2 and user3, respectively) corresponding to the user features, the processor 140 may identify user1 who has the user feature (e.g., men in their thirties) that corresponds to the designated content feature, for example, the genre of sports broadcasted at midnight.

Then, the processor 140 performs a content-related operation regarding the identified user in 303 (operation 304).

Here, the content-related operation includes a customized service, that is, targeted service which corresponds to the user feature of the identified user. For example, the processor 140 may allow the external apparatus 20 to provide the targeted advertising based on the identified user feature.

For example, an automobile advertising which is targeted to men in their thirties who has the user feature of user1 identified in the operation 303 may be provided through the external apparatus 20.

Here, the electronic apparatus 10 may directly perform the content-related operation or allow other apparatuses, for example, an advertising server to perform the content-related operation to the external apparatus 20 by outputting the identified information to the advertising server.

In an embodiment, the foregoing operations of the processor 140 may be embodied by a computer program stored in the computer program product provided separately from the electronic apparatus 10.

The computer program product may include a memory in which an instruction corresponding to a computer program is stored, and the computer program may cause a processor to perform one or more operations based on the instruction. When executed by the processor, the instruction includes obtaining user data of a viewing history of a plurality of contents, identifying two or more user features based on first reference data regarding relations between the user features of a plurality of users and the viewing tendency, identifying a user who has a user feature corresponding to a designated content feature among the plurality of users based on second reference data regarding relations between the user feature and the content features of the plurality of contents.

The electronic apparatus 10 may download and execute a computer program stored in a separate computer program product, and perform the operations of the processor 140.

The processor 140 of the electronic apparatus 10 according to an embodiment of the disclosure may perform operations using an artificial intelligence (AI) model.

The AI model may be obtained through learning sample data. Here, the AI model may learn by itself through a predefined operation rule based on learning data using algorithms for learning-based processing such as machine learning, deep learning, etc. The AI model may include a plurality of neural network layers. Each of the plurality of neural network layers has a plurality of weights, and performs a neural network operation by an operation between an operated result of a previous layer and the plurality of weights.

Inference/prediction is a technique to logically infer and predict by judging information and includes knowledge/probability-based reasoning, optimization prediction, preference-based planning, recommendation, etc.

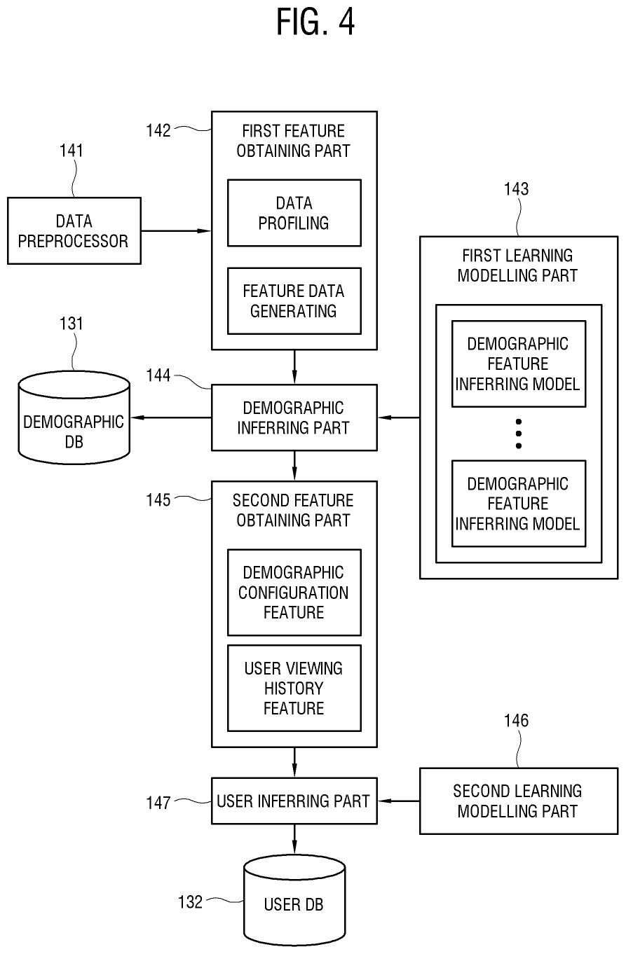

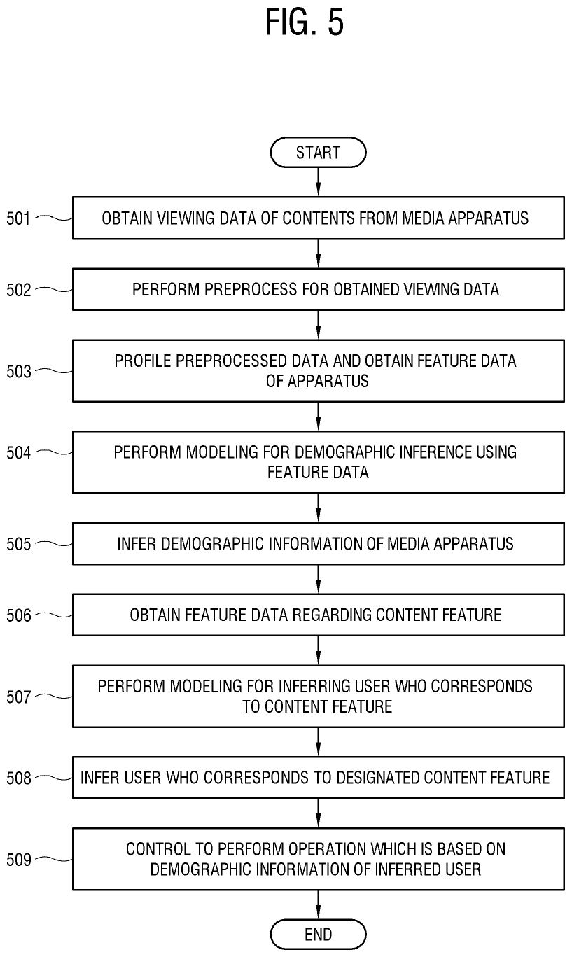

FIG. 4 illustrates a block diagram of a processor of an electronic apparatus according to an embodiment of the disclosure. FIG. 5 illustrates a flowchart of control operations of identifying the user feature and the user of the electronic apparatus according to an embodiment of the disclosure.

The control operations illustrated in FIG. 5 are embodied to infer the user feature for a media apparatus and the user corresponding to the content feature. Each of the control operations illustrated in FIG. 5 may be obtained by specifying the control operations described in FIG. 3 or adding thereto.

The processor 140 of the electronic apparatus 10 according to an embodiment of the disclosure includes, as illustrated in FIG. 4, a data preprocessor 141, a first feature obtaining part 142, a first learning modelling part 143, a demographic inferring part 144, a second feature obtaining part 145, a second learning modelling part 146, and a user inferring part 147.

The configurations of the processor 140 or a combination thereof may be embodied as a software module, a hardware module or a combination thereof or a computer program described above. Below, operations performed by the data preprocessor 141, the first feature obtaining part 142, the first learning modelling part 143, the demographic inferring part 144, the second feature obtaining part 145, the second learning modelling part 146, and the user inferring part 147 are to be understood that the processor 140 performs the operations.

The data preprocessor 141 illustrated in FIG. 4 obtains the viewing data of the contents from the media apparatus as illustrated in FIG. 5 (operation 501).

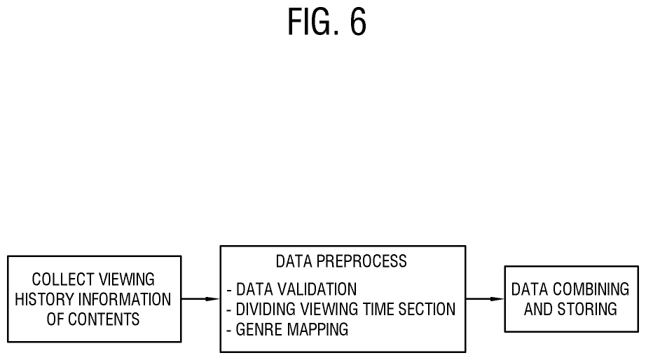

FIG. 6 illustrates operations of the data preprocessor of the electronic apparatus according to an embodiment of the disclosure.

The data preprocessor 141, as illustrated in FIG. 6, collects viewing history information of the contents as the viewing data of the media apparatus including a TV. Here, the data preprocessor 141 may collect the viewing data according to a predefined time section, for example, by dividing a day into six time sections.

In an embodiment, the data preprocessor 141 collects the viewing data from each of a plurality of media apparatuses, and the collected data is used for learning by a preprocess and obtaining of the feature data described below.

In an embodiment, the collected data obtained by the data preprocessor 141 may include apparatus usability data of the media apparatus. The apparatus usability data may include whether to use another apparatus connected through the media apparatus, whether to use an application supporting a smart function, etc.

The data preprocessor 141 performs the preprocess for the viewing data obtained in the operation 501 illustrated in FIG. 5 (operation 502).

The preprocess includes data validation to be performed as a validity check for the collected data.

The data preprocessor 141 may perform the data validation by cleansing (or removing) data that is not valid among the collected viewing data. The data preprocessor 141 may eliminate data, which is considered as an invalid value, where viewing time is less than a preset reference time or more than another preset reference time. For example, the data preprocessor 141 may determine that data is not valid when a viewing time is less than 5 minutes or more than 10 hours. However, this is only an example, and a preset reference time may be variously determined according to an input by a user or a manufacturer.

The preprocess includes classifying and mapping the data on which the cleansing has been performed.

The data preprocessor 141 may divide and classify the viewing data by a predefined viewing time section, for example, one hour.

Also, the data preprocessor 141 may map the viewing data into predefined general genres as an upper concept of a program title. Here, the genres are included in the content feature described above. That is, the data preprocessor 141 may divide and classify the viewing data in accordance with the content feature.

The data preprocessor 141 may map the program titles of the viewing data into, for example, fifty genres. However, this is only an example and the type or number of the genres are not limited thereto. Because the number of data dimensions are reduced by mapping into each genre, it is easier to perform machine learning using algorithms when the data dimensions are higher, and prevent overfitting.

The data preprocessor 141 may also perform the preprocess on the collected apparatus usability data.

The data preprocessor 141 applies machine learning to the data by combining and storing the viewing data that is collected through the preprocess.

The first feature obtaining part 142 illustrated in FIG. 4 profiles the data preprocessed in the operation 502 in FIG. 5 and obtains feature data or feature of the apparatus (operation 503).

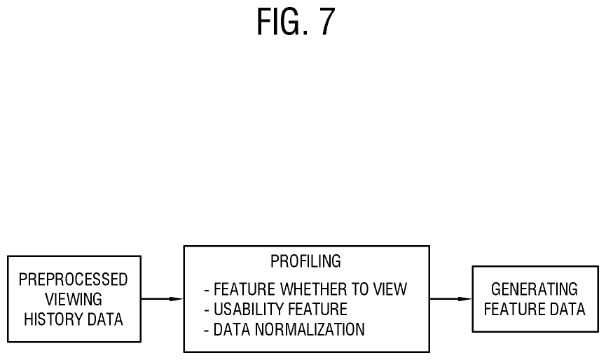

FIG. 7 illustrates operations of the first feature obtaining part of the electronic apparatus according to an embodiment of the disclosure.

The first feature obtaining part 142, as illustrated in FIG. 7, performs profiling on the viewing history data of the media apparatus that is preprocessed by the data preprocessor 141 and obtains the feature data which has a number of features that represent each of the media apparatuses.

In an embodiment, the first feature obtaining part 142 allows the first learning modelling part 143 to perform learning according to algorithms by obtaining feature data of each media apparatus and providing the data to the first learning modelling part 143.

The first feature obtaining part 142 may aggregate the viewing data by a designated time section such as one month, six months, etc., and generate a feature vector from the aggregated data. The designated time section may be defined as a unit of two weeks, one month, six months, one year, etc., but is not limited thereto. When a number of contents that are viewed by the user and viewing time is not sufficient or too short, it is difficult to learn a model due to sparse feature data, so a proper time section may be designated to aggregate the data.

In an embodiment, the first feature obtaining part 142 may generate the feature data which indicates whether to view or not in response to the content feature (time, genre, etc.)

Specifically, the first feature obtaining part 142 may not generate the feature data which indicates whether to view the content of a certain genre for a duration in which viewing continues, but for a certain time section, for example, one hour or dividing a day into parts.

Specifically, the first feature obtaining part 142 generates the feature data as 1 when, for example, a content of a comedy genre during a prime time on Feb. 1, 1990 is viewed through the media apparatus, and as 0 when not viewed.

Also, the first feature obtaining part 142 aggregates the data by the designated time section to generate the feature data. For example, the feature data may be generated based on a result of counting a number of viewing the content of the comedy genre at a prime time within six months.

In an embodiment, the first feature obtaining part 142 may further generate the feature data from the preprocessed apparatus usability data. For example, the feature data may be generated as a feature vector which indicates whether to use other connected apparatuses, a smart function, etc., as well as identification information of the other connected apparatuses such as a manufacturer name.

The first feature obtaining part 142 normalizes the feature data obtained and generated above. A feature scaling may be performed through the normalization. As a method of the normalization, MinMax, MaxAbs, standardization, etc. may be used, but is not limited thereto.

In an embodiment, the first feature obtaining part 142 may further generate a label set as answer data for learning. That is, if the viewing data already includes the user feature, such as demographic information, the demographic information may be identified by labeling as the user feature without performing demographic inference which will be described below.

The label set may be generated by using the demographic information which is categorized or grouped in advance. Here, age data as the demographic information may be used continuously or be changed categorically to be used. As an example of categorically changing to use, the demographic information such as age, gender, etc. may be categorized into a number of categories. For example, the demographic information may be categorized and grouped into fourteen categories such as female under an age of 18, female of 18 to 24, female of 25 to 34, female of 35 to 44, female of 45 to 54, female of 55 to 64, female of 65 to 99, male under 18, male of 18 to 24, male of 25 to 34, male of 35 to 44, male of 45 to 54, male of 55 to 64, male of 65 to 99, etc. However, the one or more embodiments are not limited thereto, and the demographic information may be categorized differently considering various other factors.

In an embodiment, the first feature obtaining part 142 is embodied to obtain the feature data for the viewing data of various types of media apparatuses. That is, the feature data may be generated to alleviate differences of algorithms among apparatuses by generating the feature data, based on the demographic inference of more universal user features. For example, since there may be deviation of result values due to the difference of algorithms when using the continuous viewing duration as feature data, it may be preferable to arrange the contents by a certain time section such as ten minutes, one hour, a divided day part, etc.

The first learning modelling part 143 illustrated in FIG. 4 may perform modeling for the user feature, that is, the demographic inference using the feature data obtained in the operation 503 illustrated in FIG. 5 (operation 504).

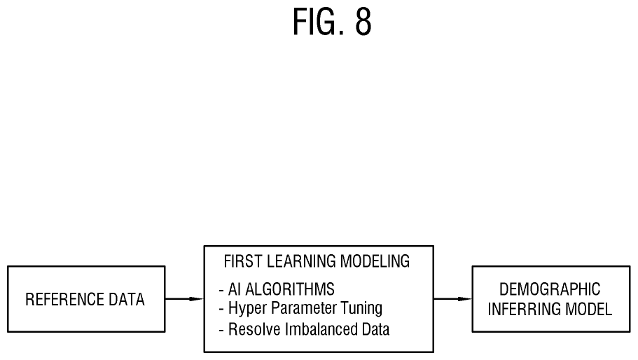

FIG. 8 illustrates operations of the first learning modelling part of the electronic apparatus according to an embodiment of the disclosure.

The first learning modelling part 143 learns a model for inferring the demographic information as the user feature. Here, the first learning modelling part 143 may perform the learning based on the first reference data.

In an embodiment, the first reference data may be based on the viewing data which is collected by the data preprocessor 141 from the plurality of media apparatuses. The first reference data includes the feature data which is obtained from the data of each media apparatus through, for example, the preprocess of the operation 502 and obtaining the feature data in the operation 503.

In an embodiment, the first learning modelling part 143 may perform the learning using techniques for solving an imbalanced data problem and enhancing model performance. The first learning modelling part 143 may use various kinds of machine learning or deep learning techniques, and perform hyper-parameter tuning for optimization.

As the learning of the first learning modelling part 143, machine learning algorithms such as random forests, decision trees, gradient boosting, etc. or AI algorithms of a deep learning neural network structure may be used, but are not be limited thereto.

The first learning modelling part 143 may generate the model for inferring the demographic information as the user feature by performing the learning using the above algorithms.

Here, the model for inferring the demographic information may be embodied as a multi-layer model. Each model may be include layered models which are divided, at a first order, into, for example, general units such as a young age, a middle age, etc. whose content viewing patterns are similar and, at an n-th order, a specific unit such as an age is inferred.

The first learning modelling part 143 may use the demographic information more flexibly through the multi-layer modeling. For example, by having the demographic information arranged in the multi-layer modelling, it is possible to flexibly process the demographic information of, for example, middle aged users when providing a targeted service using the demographic information, or when more specific demographic information of, for example, users at age 20 is needed.

Also, the first learning modelling part 143 may further proceed with cross-validation such as n-fold cross-validation or hold-out in order to validate a model generated by learning and enhance generalization performance.

The first learning modelling part 143 may apply, when the demographic information has an imbalanced feature, cost-sensitive learning, over-sampling, a generative model, etc. for supplementation. For example, because the data in which TVs used by women of 24 to 35 years old are about 15% of all is fairly imbalanced, the model is guided for solving the problem to well perform learning on a minority class using the cost-sensitive learning, the over-sampling, the generative model, etc.

For example, in case of proceeding with binary classification supposing that the minority class is one, the cost-sensitive learning may guide the model to learn the minority class by increasing loss weight regarding false negative during the learning of the model.

Another example, the over-sampling is a method of minimizing the imbalance by making data belongings to the minority class similar data, where Synthetic Minority Oversampling Technique (SMOTE), Adaptive Synthetic Sampling (ADASYNC) algorithm, Variational Autoencoder (VAE), etc. may be applied.

Because age groups as the demographic information are very similar in the viewing pattern, the first learning modelling part 143 may enhance the performance of the model by performing the learning with the model being configured to be, for example, two layers.

For example, because women groups of 18 to 24, 25 to 34, and 35 to 44 years old represent to have similar content viewing patterns, when inferring the demographic information using a single model, the user feature of the apparatus might have a tendency to be inferred as every women groups.

In order to prevent the problem from occurring, the first learning modelling part 143 performs the learning with the inference model which is configured to be a top model and a down model. For example, the top model infers as binary classification whether women of 18 to 44 years old use the media apparatus or not, whereas, when it is inferred that women of 18 to 44 years old use the media apparatus, the down model allows as multi-class prediction the model to learn to select which of women groups of 18 to 24, 25 to 34, and 35 to 44 years old uses the media apparatus using the down model. Also, the first learning modelling part 143 may validate the model by proceed with 4-fold cross-validation and enhance the generalization performance.

The demographic inferring part 144 illustrated in FIG. 4 infers the user feature of the media apparatus, that is, the demographic information from the feature data obtained in the operation 503 by using the model learning in the operation 504 illustrated in FIG. 5 (operation 505).

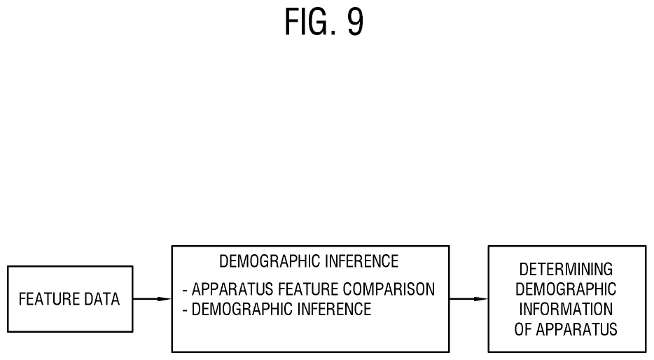

FIG. 9 illustrates operations of the demographic inferring part of the electronic apparatus according to an embodiment of the disclosure.

In an embodiment, the demographic inferring part 144 may determine the demographic information or user feature of the media apparatus by comparing the feature data of the media apparatus which is obtained by performing the profiling in the operation 503 illustrated in FIG. 5 and the demographic information or user feature of at least one user using the model learning in the operation 504 illustrated in FIG. 5.

In an embodiment, the demographic inferring part 144 may infer the demographic information using the feature data which is obtained for the media apparatus having no answer data, that is, label set.

The determined user feature, that is, demographic information may be stored and managed, matching each of the media apparatuses, in a database 131 which is provided in the storage 130.

The demographic inferring part 144 may infer two or more user features for the media apparatus in the operation 505. For example, two or more user features which correspond to users of a household who commonly use the media apparatus such as a TV may be inferred.

The second feature obtaining part 145 illustrated in FIG. 4 obtains the feature data regarding the content feature for the media apparatus where the two or more user features are inferred in the operation 505 illustrated in FIG. 5 (operation 506). Here, the second feature obtaining part 145 may obtain the feature data regarding the content feature by profiling the data preprocessed in the operation 502.

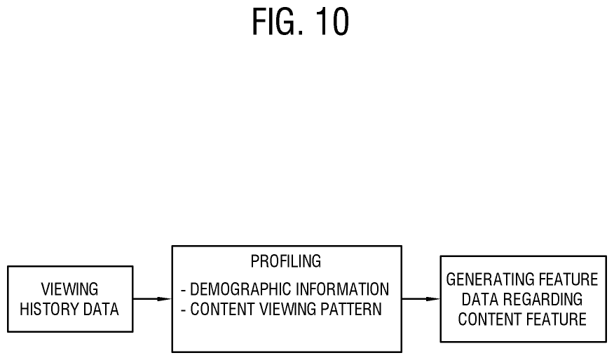

FIG. 10 illustrates operations of the second feature obtaining part of the electronic apparatus according to an embodiment of the disclosure.

The second feature obtaining part 145, as illustrated in FIG. 10, may perform profiling on the viewing history data of the media apparatus and obtain the feature data representing, for example, genre or time information of the viewed content.

The second feature obtaining part 145 may generate the feature data based on the demographic information, for example, n people of adult, n people of children, etc. inferred for the media apparatus in the operation 505 and profiling using the content viewing pattern, etc. Here, the content viewing pattern may be obtained by the data preprocessor 141 based on the data divided by the viewing time section and mapped into the genres.

Here, the second feature obtaining part 145 obtains the feature data which represents the viewing pattern of the content for two or more users who have two or more user features of the media apparatus inferred from the preprocessed viewing data.

In an embodiment, the second feature obtaining part 145 allows the second learning modelling part 146 to perform learning in accordance with algorithms by providing the second learning modelling part 146 with the obtained feature data of the media apparatus.

The second feature obtaining part 145 may further use the preprocessed apparatus usability data in generating the feature data.

The generated feature data may be a feature vector for identifying a user who watches a program having a designated content feature, for example, at a particular time or of a particular genre.

The second learning modelling part 146 illustrated in FIG. 4 performs modeling for inferring a user who corresponds to the content feature using the feature data obtained in the operation 506 illustrated in FIG. 5 (operation 507).

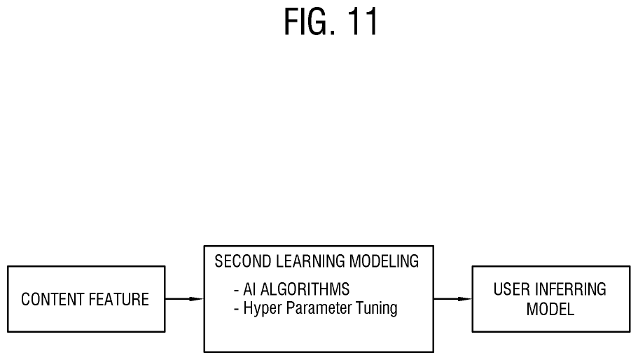

FIG. 11 illustrates operations of the second learning modelling part of the electronic apparatus according to an embodiment of the disclosure.

The second learning modelling part 146 learns a model to infer the user, e.g., one of household members who watches the program having the designated content feature, for example, at the particular time or of the particular genre among two or more users, e.g., the household members who have two or more user features (demographic information) inferred in the operation 505. Here, the second learning modelling part 146 may perform learning based on second reference data.

The second reference data includes, for example, the feature data which is obtained from the data of the media apparatus through the operations 502 and 506.

In an embodiment, the second learning modelling part 146 may use various techniques of machine learning or deep learning and proceed with hyper-parameter tuning for optimization.

In learning of the second learning modelling part 146, are used machine learning algorithms such as random forest, decision tree, gradient boosting, etc. or deep learning neural network-based AI algorithms, but are not limited thereto.

The second learning modelling part 146 may generate a model for inferring a user who has the user feature corresponding to a certain content feature, for example, time information of a certain time or program information of a certain genre by performing learning with the algorithms. Here, the content feature may not be limited to the certain time or genre, but further include a program title, a main character, playing time, etc.

The user inferring part 147 illustrated in FIG. 4 infers a user who corresponds to the designated content feature by using the model learning in the operation 507 illustrated in FIG. 5 (operation 508).

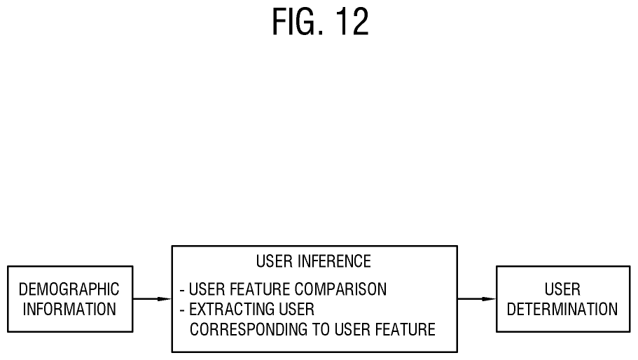

FIG. 12 illustrates operations of the user inferring part of the electronic apparatus according to an embodiment of the disclosure.

In an embodiment, the user inferring part 147 may infer for each media apparatus the user who corresponds to the designated content feature, by using the model learning in the operation 507, among users who correspond to two or more demographic information inferred in the operation 505.

Accordingly, the user who mainly watches a content of the designated content feature may be determined among a plurality of household members who use the media apparatus such as TV commonly.

In an embodiment, the user inferring part 147 may infer the user based on a probability value. That is, the user inferring part 147 may obtain the probability value using the leaned model for each of the two or more users who correspond to the two or more demographic information and infer a user whose probability value is highest among the users as the user corresponding to the content feature.

For example, if the probability values are obtained as Table 1 below, user 1 may be determined as the user who has the user feature (demographic information) corresponding to the designated content feature among the users of the media apparatuses.

TABLE 1

| | user 1 | user 2 | user 3 | user 4 |
|---|---|---|---|---|
| probability value | 0.5 | 0.3 | 0.1 | 0.1 |

Here, if the difference between the obtained probability values is within a predefined threshold, a plurality of users who correspond to the content feature may be inferred, from which may be understood that the plurality of users watch together at the media apparatus such as TV that is commonly used by the household members.

The determined user, that is, the household member information may be matched with each media apparatus and be stored and managed in a user DB 132 provided in the storage 130.

The processor 140 may control to perform an operation which is based on the content feature of the user inferred in the operation 508 at the media apparatus, that is, the demographic information (operation 509). Here, the content-related operation is a customized service which corresponds to the user feature of the inferred user, that is, the demographic information, for example, a targeted service such as advertisement.

For example, the processor 140 allows the targeted service such as advertisement based on the user feature according to the content feature to be output through the media apparatus by storing and managing for each media apparatus the user information which has the user feature (demographic information) corresponding to the content feature to provide the information to an advertisement server. Here, although the media apparatus is used commonly by a plurality of users, it is possible to provide an accurate targeted service to the user who has the user feature corresponding to the designated content feature among the plurality of users.

The electronic apparatus 10 according to an embodiment of the disclosure is able to enhance reliability of demographic inference by inferring in a manner of two steps: first, identifying the demographic information of the media apparatus based on the viewing history information and then identifying a user who corresponds to the content feature when two or more user features are identified.

Also, because the user of the media apparatus, for example, a user who actually watches among the household members by directly using the viewing history information of the media apparatus which is to be provided with a service, it is possible to infer in a more reliable manner.

Accordingly, there is an advantage of maximizing an effect of a service or marketing such as targeted advertising for a user group in which the user feature, that is, demographic information is identified.

According to an embodiment, a method according to various embodiments of the disclosure may be provided as involved in a computer program product. The computer program product may be traded as goods a commodity between a seller and a purchaser. The computer program product may be distributed in the form of a machine-readable storage medium (e.g. a compact disc read only memory (CD-ROM)), or may be distributed (e.g. downloaded or uploaded) directly between two user devices (e.g. smartphones) through an application store (e.g. The Play Store™) or through the Internet. In a case of the Internet distribution, at least a part of the computer program product (e.g. a downloadable app) may be at least transitorily stored or temporarily generated in a machine-readable storage medium such as a server of a manufacturer, a server of the application store, or a memory of a relay server.

As described above, the electronic apparatus and the control method thereof according to an embodiment of the disclosure are able to provide the targeted service efficiently by identifying the user feature from the viewing data of the content.

Also, according to an embodiment of the disclosure, it is possible to provide the targeted service more precisely by specifying a user who actually watches the content among a plurality of users.

Although some example embodiments have been shown and described, it will be appreciated by those skilled in the art that changes may be made in these embodiments without departing from the principles and spirit of the disclosure, the scope of which is defined in the appended claims and their equivalents.

What is claimed is:

1. An electronic apparatus comprising:
a processor configured to:
obtain user data regarding a viewing history of a plurality of contents for each of a plurality of users;
determine a viewing tendency of each of the plurality of users based on the viewing history;
identify at least two user features corresponding to the viewing tendency based on first reference data regarding relations between user features of the plurality of users and the viewing tendency, the first reference data being provided based on viewing histories of the plurality of users for the plurality of contents;
identify a target user having a user feature corresponding to a designated content feature among at least two users having the identified at least two user features based on second reference data regarding relations between the user feature and content features of the plurality of contents, the second reference data being provided based on the viewing history of the plurality of users; and
perform a content-related operation regarding the target user.

2. The electronic apparatus according to claim 1, wherein the user feature corresponds to one of a plurality of groups which are divided according to at least one of age or gender of the plurality of users.

3. The electronic apparatus according to claim 1, wherein the designated content feature is determined based on at least one of genre or time section of a content among the plurality of contents.

4. The electronic apparatus according to claim 1, further comprising an interface circuitry,
wherein the processor is further configured to receive viewing data regarding the plurality of contents from an external apparatus through the interface circuitry, and obtain the user data regarding the viewing tendency from the viewing data.

5. The electronic apparatus according to claim 1, wherein the processor is further configured to classify and map viewing data of the plurality of contents collected from a plurality of external apparatuses, to the content features of the plurality of contents, and obtain, from the classified and mapped viewing data, feature data which indicates whether to view at each of the plurality of external apparatuses for the content features.

6. The electronic apparatus according to claim 5, wherein the processor is further configured to identify the at least two user features corresponding to the viewing tendency of the user data by performing learning based on the first reference data, and
the first reference data comprises the classified and mapped viewing data to the content features and the obtained feature data.

7. The electronic apparatus according to claim 6, wherein the processor is further configured to identify the at least two user features which correspond to the viewing tendency by comparing the feature data obtained from an external apparatus and a user feature obtained from a learned model.

8. The electronic apparatus according to claim 7, wherein the learned model comprises multi-layers.

9. The electronic apparatus according to claim 5, wherein the processor is further configured to obtain, from the classified and mapped viewing data, the feature data which indicates a viewing pattern of content for the at least two users having the at least two user features.

10. The electronic apparatus according to claim 9, wherein the processor is further configured to identify the target user having the user feature corresponding to the designated content feature by performing learning based on the second reference data, and
the second reference data comprises the classified and mapped viewing data to the content features and the obtained feature data.

11. A method of controlling an electronic apparatus, the method comprising:
obtaining user data regarding a viewing history of a plurality of contents for each of a plurality of users;
determine a viewing tendency of each of the plurality of users based on the viewing history;
identifying at least two user features corresponding to the viewing tendency based on first reference data regarding relations between user features of the plurality of users and the viewing tendency, the first reference data being provided based on viewing histories of the plurality of users for the plurality of contents;
identifying a target user having a user feature corresponding to a designated content feature among at least two users having the identified at least two user features based on second reference data regarding relations between the user feature and content features of the plurality of contents, the second reference data being provided based on the viewing history of the plurality of users, and
performing a content-related operation regarding the target user.

12. The method according to claim 11, wherein the user feature corresponds to one of a plurality of groups which are divided according to at least one of age or gender of the plurality of users.

13. The method according to claim 11, wherein the designated content feature is determined based on at least one of genre or time section of a content among the plurality of contents.

14. The method according to claim 11, wherein the obtaining comprises:
receiving viewing data regarding the plurality of contents from an external apparatus through an interface circuitry, and
obtaining the user data regarding the viewing tendency from the viewing data.

15. The method according to claim 11, further comprising:
classifying and map viewing data of the plurality of contents collected from a plurality of external apparatuses, to the content features of the plurality of contents, and
obtaining, from the classified and mapped viewing data, feature data which indicates whether to view at each of the plurality of external apparatuses for the content features.

16. The method according to claim 15, wherein the identifying the at least two user features comprises identifying the at least two user features corresponding to the viewing tendency of the user data by performing learning based on the first reference data, and
the first reference data comprises the classified and mapped viewing data to the content features and the obtained feature data.

17. The method according to claim 16, wherein the identifying the at least two user features comprises identifying the at least two user features which correspond to the viewing tendency of the user data by comparing the feature data obtained from an external apparatus and a user feature obtained from a learned model.

18. The method according to claim 15, wherein the classifying and mapping comprises obtaining, from the classified and mapped viewing data, the feature data which indicates a viewing pattern of content for the at least two users having the at least two user features.

19. The method according to claim 18, wherein the identifying the target user comprises identifying the target user having the user feature corresponding to the designated content feature by performing learning based on the second reference data, and
the second reference data comprises the classified and mapped viewing data to the content features and the obtained feature data.

20. A non-transitory computer-readable recording medium storing instructions which are executed by an electronic apparatus to perform a method, the method comprising:
obtaining user data regarding a viewing history of a plurality of contents for each of a plurality of users;
determining a viewing tendency of each of the plurality of users based on the viewing history;
identifying at least two user features corresponding to the viewing tendency based on first reference data regarding relations between user features of the plurality of users and the viewing tendency, the first reference data being provided based on a viewing histories of the plurality of users for the plurality of contents;
identifying a target user having a user feature corresponding to a designated content feature among at least two users having the identified at least two user features based on second reference data regarding relations between the user feature and content features of the plurality of contents, the second reference data being provided based on the viewing history of the plurality of users, and
performing a content-related operation regarding the target user.
